(19) United States
(12) Patent Application Publication
(10) Pub. No.: US 2024/0300850 A1
(43) Pub. Date: Sep. 12, 2024

(54) PYRO LIGHT ENAMEL COATING

(71) Applicant: PEMCO Belgium BV, Bruges (BE)

(72) Inventors: Sander PIETERS, Bruges (BE); Kris SIMOENS, Bruges (BE); Koen LIPS, Bruges (BE)

(73) Assignee: PEMCO Belgium BV, Bruges (BE)

(21) Appl. No.: 18/578,524

(22) PCT Filed: Jul. 15, 2022
(86) PCT No.: PCT/EP2022/069948

§ 371 Date: Jan. 11, 2024

(30) Foreign Application Priority Data
Jul. 16, 2021 (BE) BE2021/5556

(51) Int. Cl. C03C 8/14; C03C 3/118; C03C 8/06; C03C 8/08; C03C 8/16; C03C 8/22; C23D 5/04

(52) U.S. Cl. CPC C03C 8/14; C03C 3/118; C03C 8/06; C03C 8/08; C03C 8/16; C03C 8/22; C23D 5/04; C03C 2207/00

(57) ABSTRACT

The invention is in the field of vitreous enamel coatings, more particularly vitreous enamel coatings for steels. The invention provides a process for obtaining adhering light-coloured coatings in a single layer system, hereinafter referred to as “Pyro Light” coatings, that can be applied to the steel by powder electrostatic spraying.

### FIELD OF THE INVENTION

The invention is in the field of vitreous enamel coatings, more particularly vitreous enamel coatings for steels. The invention provides a process for obtaining adhering light-coloured coatings in a single layer system, hereinafter referred to as “Pyro Light” coatings, that can be applied to the steel by powder electrostatic spraying.

### BACKGROUND OF THE INVENTION

Enamel can be classified as a glass due to its composition that is mainly based on silicon dioxide (>30%) and several other oxides, such as boric oxide, sodium oxide and potassium oxide, which are cross-linked to form a three-dimensional network. Many other oxides are added in enamels to set/obtain the physical and chemical properties.

Enamelling involves the application of a, for example, dark-coloured enamel layer to a steel object that reacts with the metal surface during the firing process to create a chemical and mechanical bond between the steel and the enamel layer. The complex reactions at the phase boundary between metal and enamel take place during firing, usually at a temperature of 760° C. to 860° C. If light colours are required, a second layer of light colour is applied on top of the dark-coloured enamel layer (this includes white, light grey, sky blue, light brown, green, etc.) and this is also fired. The layer thickness of this composite enamel coating is higher, which means that some properties, e.g., those required for an enamel coating in a cooker, are no longer attainable.

To obtain light colours with a single-layer system, new enamel coatings were developed that are not dark-coloured and still have all the properties needed for most applications, including use in cookers.

### BRIEF DESCRIPTION OF THE FIGURES

FIG. 1: Surface of the enamel layer according to the invention.

FIG. 2: Test set-up to determine the expansion coefficient and compressive stress of the enamel layer using the KLOTZ test, DIN51175.

FIG. 3: Graph showing the determined compressive and tensile stress of the enamel layer according to the invention.

### DESCRIPTION OF THE INVENTION

This invention describes a new and innovative way to obtain light-coloured enamel coatings in a single layer system, preferably with limited layer thickness.

The term “preferred embodiment” herein is understood as embodiments which specifies the present invention. Thus, anything which is called “preferred embodiment” or labelled as “preferably”, “preferred”, etc. shall be understood as “preferred embodiment”.

The invention relates to a molybdenum-containing frit comprising
(a) molybdenum oxide, preferably in form of MoO₃, and
(b) antimony oxide, preferably in form of Sb₂O₃.

By the present invention it is possible to apply a light-coloured enamel coating as a single layer system to a metal substrate, preferably steel. In the prior art a two-layered system had to be applied, namely a dark coloured basis layer which was used for providing the sufficient adherence to the metal substrate and a light-coloured cover layer which was applied on top of this dark coloured basis layer. By the specific composition of the molybdenum-containing frit, namely using antimony oxide, preferably in combination with iron oxide, preferably ferric oxide, a direct application of light-coloured layer to a metal substrate is possible. Thus, the molybdenum-containing frit according to the present invention can be applied to the metal surface without any extra pre-treatment (e.g., nickel-dipping, and ground coating) of the metal substrate, besides degreasing.

In a preferred embodiment the molybdenum-containing frit further comprises iron oxide, preferably in form of Fe₂O₃.

Preferably, molybdenum-containing frit comprises molybdenum oxide in form of MoO₃, antimony oxide in form of Sb₂O₃ and iron oxide in form of Fe₂O₃. By using antimony oxide, preferably in combination with iron oxide, preferably ferric oxide, chemical adherence can be obtained between an enamel layer produced from the molybdenum-containing frit either alone or in combination with a crystallizing frit and a metal substrate, preferably steel. The presence of the antimony oxide, preferably in combination with iron oxide, preferably ferric oxide, result in a significant increase in the chemical adherence performance.

Preferably, the molybdenum oxide, preferably MoO₃, is present in an amount of 0.5 to 3.0% by weight, preferably 1.0 to 2.0% by weight (based on the total dry weight of the molybdenum-containing frit).

Preferably, the antimony oxide, preferably Sb₂O₃, is present in an amount of 0.1 to 3.0% by weight, preferably 0.2 to 2.0 by weight (based on the total dry weight of the molybdenum-containing frit).

Preferably, the iron oxide, preferably Fe₂O₃, is present in an amount of 1.0 to 5.0% by weight, preferably 1.5 to 4.0% by weight, preferably 2.0 to 3.5% by weight (based on the total dry weight of the molybdenum-containing frit).

Preferably, the antimony oxide, preferably Sb₂O₃, and the iron oxide, preferably Fe₂O₃, are present together in an amount of 2.0 to 8.0% by weight, preferably 3.0 to 5.0% by weight (based on the total dry weight of the molybdenum-containing frit).

Preferably, the molybdenum oxide, preferably MoO₃, the antimony oxide, preferably Sb₂O₃, and the iron oxide, preferably Fe₂O₃, are present together in an amount of 3.0 to 10.0% by weight, preferably 4.5 to 6.0% by weight (based on the total dry weight of the molybdenum-containing frit).

In a preferred embodiment the molybdenum-containing frit is free of cobalt oxide and/or nickel oxide, preferably in form of CoO and NiO. The content of cobalt oxide and/or nickel oxide is preferably less than 0.1% by weight, preferably less than 0.01% by weight (based on the total dry weight of the molybdenum-containing frit composition). The presence of cobalt oxide and/or nickel oxide which are usually used for adhering an enamel to a metal substrate is not required any longer by using the adhering system of the present invention (molybdenum oxide and antimony oxide, preferably in combination with ferric oxide).

In a preferred embodiment the molybdenum-containing frit contains at least 50% by weight SiO₂ (based on the total dry weight of the molybdenum-containing frit).

Preferably, the molybdenum-containing frit contains at least 50% by weight SiO₂ in combination with TiO₂ (based on the total dry weight of the molybdenum-containing frit).

In a preferred embodiment the molybdenum-containing frit contains 1 to 8% by weight TiO₂ (based on the total dry weight of the molybdenum-containing frit).

In a preferred embodiment the molybdenum-containing frit contains less than 3% by weight Fluor (based on the total dry weight of the molybdenum-containing frit).

In a preferred embodiment the molybdenum-containing frit contains 10 to 20% by weight alkali oxides, preferably K₂O, Na₂O and Li₂O, (based on the total dry weight of the molybdenum-containing frit).

In a preferred embodiment the molybdenum-containing frit contains less than 10% by weight, preferably 4.0 to 8.5% by weight earth alkali oxides, preferably BaO and CaO (based on the total dry weight of the molybdenum-containing frit).

In the food technology it is unacceptable that certain amounts of certain metals leach from the enamel into the food, which is later consumed and therefore exposed to these materials. Hence, the enamel coatings need to be strongly chemical resistant and need to surpass the ISO4531-norm (explained in more detail below). To pass the ISO4531-norm, a certain acid resistance is required to avoid an excess of leaching of harmful elements into the consumers' food. In order to obtain said chemical resistance the molybdenum-containing frit and/or the overall frit composition shall contain at least 50% by weight SiO₂, preferably in combination with TiO₂, a low F-content (i.e. less than 3% by weight), a low alkali-content (K₂O/Na₂O/Li₂O 10 to 20 wt.-%, preferably approx. 15 wt.-%) and a low earth-alkali content (i.e. less than 10%).

In a preferred embodiment the molybdenum-containing frit contains at least three, preferably at least five, preferably all the following components (each % by weight is based on the total dry weight of the molybdenum-containing frit):
MoO₃, preferably 0.5 to 3.0% by weight thereof, preferably 1.0 to 2.0% by weight thereof,
Sb₂O₃, preferably 0.1 to 3.0% by weight thereof, preferably 0.2 to 2.0% by weight thereof,
Fe₂O₃, preferably 1.0 to 5.0% by weight thereof, preferably 1.5 to 4.0% by weight thereof,
Al₂O₃, preferably 0.5 to 3.0% by weight thereof, preferably 0.5 to 1.0% by weight thereof,
B₂O₃, preferably 5.0 to 20.0% by weight thereof preferably 10.0 to 16.0% by weight thereof,
BaO, preferably 1.0 to 10.0% by weight thereof preferably 3.0 to 8.0% by weight thereof,
CaO, preferably 0.1 to 5.0% by weight thereof preferably 1.0 to 1.5% by weight thereof,
F, preferably 0.1 to 5.0% by weight thereof, preferably 0.5 to 3.0% by weight thereof,
K₂O, preferably 0.5 to 10.0% by weight thereof preferably 1.0 to 6.0% by weight thereof,
Li₂O, preferably 0.1 to 3.0% by weight thereof preferably 0.3 to 1.5% by weight thereof,
Na₂O, preferably 5.0 to 20.0% by weight thereof preferably 8.0 to 13.0% by weight thereof,
SiO₂, preferably 40.0 to 60.0% by weight thereof, preferably 50.0 to 55.0% by weight thereof, and
TiO₂, preferably 1.0 to 8.0% by weight thereof, preferably 2.0 to 4.0% by weight thereof,
wherein all components add up to 100% by weight.

The invention relates to a frit composition comprising:
(a) a molybdenum-containing frit according to the present invention or a preferred embodiment thereof; and
(b) a crystallizing frit.

The crystallizing frit according to the present invention has preferably a higher melting point than the molybdenum-containing frit. Preferably, the crystallizing frit does not melt during the enamel coating process but solely the micro-crystals thereof adhere to each other.

In a preferred embodiment the crystallizing frit contains cerium oxide, preferably in form of CeO₂, preferably 5.0 to 20.0% by weight thereof, preferably 10.0 to 15.0% by weight thereof, and/or silicon oxide, in form of SiO₂, preferably 40.0 to 60.0% by weight thereof, preferably 45.0 to 55.0% by weight thereof.

In a preferred embodiment the crystallizing frit contains at least three, preferably at least five, preferably all the following components (each % by weight is based on the total dry weight of the crystallizing frit):
MoO₃, preferably less than 1.0% by weight thereof, preferably less than 0.5% by weight thereof,
Al₂O₃, preferably 0.5 to 5.0% by weight thereof, preferably 1.0 to 2.0% by weight thereof,
B₂O₃, preferably 5.0 to 20.0% by weight thereof, preferably 10.0 to 15.0% by weight thereof,
BaO, preferably 0.1 to 5.0% by weight thereof, preferably 0.1 to 0.5% by weight thereof,
CaO, preferably 0.5 to 5.0% by weight thereof, preferably 1.0 to 1.5% by weight thereof,
CeO₂, preferably 5.0 to 20.0% by weight thereof, preferably 10.0 to 15.0% by weight thereof,
F, preferably 0.5 to 5.0% by weight thereof, preferably 1.5 to 2.5% by weight thereof,
K₂O, preferably 0.1 to 5.0% by weight thereof, preferably 2.0 to 4.0% by weight thereof,
Li₂O, preferably 0.1 to 5.0% by weight thereof, preferably 0.5 to 1.5% by weight thereof,
MgO, preferably 0.1 to 5.0% by weight thereof, preferably 0.5 to 1.5% by weight thereof,
Na₂O, preferably 5.0 to 15.0% by weight thereof, preferably 8.0 to 12.0% by weight thereof,
SiO₂, preferably 40.0 to 60.0% by weight thereof, preferably 45.0 to 55.0% by weight thereof,
TiO₂, preferably 1.0 to 5.0% by weight thereof, preferably 2.0 to 4.0% by weight thereof, and
ZrO₂, preferably 1.0 to 5.0% by weight thereof, preferably 3.0 to 4.0% by weight thereof,
wherein all components add up to 100% by weight.

In a preferred embodiment the frit composition contains, preferably consists of, 40 to 95% by weight of the molybdenum-containing frit and 5 to 60% by weight of the crystallizing frit. Preferably, the frit composition contains, preferably consists of, 40 to 60% by weight of the molybdenum-containing frit and 40 to 60% by weight of the crystallizing frit. Preferably, the frit composition contains, preferably consists of, 45 to 55% by weight of the molybdenum-containing frit and 45 to 55% by weight of the crystallizing frit.

Preferably, the frit composition is free of cobalt oxide and/or nickel oxide, preferably in form of CoO and NiO. The content of cobalt oxide and/or nickel oxide is preferably less than 0.5% by weight, preferably less than 0.1% by weight (based on the total dry weight of the frit composition).

The invention relates to an enamel coating composition comprising:
(a) a frit composition according to the present invention or a preferred embodiment thereof; and
(b) a liquid medium.

In a preferred embodiment the liquid medium in the enamel coating composition is an oil and/or a solvent. The oil is preferably polymethylhydrosiloxane.

In a preferred embodiment the enamel coating composition further contains at least one of the components selected from the group consisting of one or more adherence promotors, one or more color pigments, one or more mill additives and combinations thereof. Preferably, enamel coating composition further comprises Sb/Ca-titanate, preferably in an amount of 1.0 to 5.0 g per 100 g frit composition, preferably as adherence promotor.

The invention relates to a method for coating metal substrate with enamel, which comprises the following steps of:
(a) providing a metal substrate having a first surface and an enamel coating composition according to the present invention or a preferred embodiment thereof;
(b) directly applying the enamel coating composition of step (a) to the first surface of the metal substrate to form a coated metal substrate; and
(c) firing the coated metal substrate to form an enamel coated metal substrate.

In a preferred embodiment the applying pursuant to step (b) is conducted by electrostatic powder spraying.

In a preferred embodiment the firing step (c) is conducted at a temperature of from 760° C. to 860° C., preferably for 2 to 10 minutes.

The invention relates to an enamel coating produced by a method according to the present invention or a preferred embodiment thereof.

In a preferred embodiment the enamel coating has a lightness value L of 20 to 70, preferably 35 to 55 (measured by using the CIELAB method). The spectrophotometer used to measure the L, a and b values was a Hunterlab Colorquest XE.

Using the adherence norm EN10209 the value of adherence of the enamel coatings according to the present invention is preferably at least 2, preferably at least 3.

Preferably, the enamel coatings have a good water resistance according to EN ISO28706-2, with a maximum leached-out mass of 10 g/m².

The enamel coating of the present invention can be used in pyrolytic ovens. These ovens can reach temperatures as high as 500° C. during the cleaning cycle. Due to this high temperature, dirt residues decompose into smaller organic molecule instead of being burned, resulting in a ‘self-cleaning’ effect. This process of ‘decomposing’ is called pyrolysis. One of the main issues with these kinds of ovens is metallization. This effect causes shiny enamel to become mat and impure after a while. For example, black enamel turns grey. Because of this shift in color, the oven may be considered dirty by the costumer. In contrast thereto, the enamel coatings of the present invention are thermally stable and chemical resistant. Thus, no change of color occurs during pyrolysis.

The enamel coatings of the present invention have preferably a F_{d}-value of 2.80 to 3.20 (measured using the “KLOTZ-test” (DIN 51175)). Accordingly, an enamel coating can withstand constant temperature changes without cracking or blistering.

The invention relates to a use of an enamel coating composition according to present invention or a preferred embodiment thereof as enamel which is directly applied to a metal substrate, preferably steel.

More particularly, the invention relates to enamel coatings which do not contain dark-colouring oxides to obtain a light colour.

In particular, the invention relates to a single-layer enamel coating that is applied to steel by electrostatic powder spraying and is directly fired at temperatures between 760° C. to 860° C. without dry treatment.

Dark colours are typical of existing single-layer enamel coatings due to the complexation of the adherence ions used, namely cobalt, nickel, manganese, copper. These have been used for decades as the main adherence promoters in enamels. The metals of the corresponding oxides are transition metals, which means that these elements originate from the d-block of the Mendeleev table. The lanthanides and actinides (f-block) also belong here, but for simplicity only the d-block is referred to. The common property of all these elements is that they have a partially filled d-sub shell in their ground state. In other words, the d-sub shell contains between 1-9 electrons. This does not apply to Zn, Cd and Hg, which also belong to the d-block, but contain a filled d-sub shell. Due to this specific electron configuration, the d-block elements have a characteristic property, namely complex formation. A complex is a compound consisting of a central transition metal ion surrounded by one or more neutral or anionic ligands. A specific property of this type of bond is that excitation of certain electrons is possible. And where there is excitation, emission follows. This phenomenon results in the dark colour of the glassy coating.

If cobalt is used, it will bind tetrahedral with various ligands, giving the enamel a dark blue colour. For nickel this will give dark brown. These ions colour strongly, making its colour dominant. This means that these colours are difficult to neutralise. This results in a limitation of possibilities with single-layer system in terms of colouring. Dark colours such as dark blue, black, and brown are easy to achieve. Other colours, however, are not possible due to the presence of these ions. At least if the other properties, such as adherence, are to be maintained.

When firing the new light-coloured enamel coatings, it is important that the steel surface is properly prepared and preferably free from oil/fat that would negatively affect the reactions between enamel and steel. At the beginning of the firing of the enamel layer on a properly prepared steel article, the steel surface preferably oxidises, and then chemical reactions occur between the iron of the steel sheet, the iron oxides, and the adherence elements in the enamel layer. To obtain the light colour, only very small amounts of dark-coloured adherence elements may be added. This is precisely the innovation of the present invention: to obtain adherence with very limited amounts of dark-coloured elements. This is preferably achieved by using the composition of the glass composition used in combination with one or more of the following aspects: the melting parameters in the production of the enamel glass, the fineness of grind of the enamel powder applied, the use of adherence promoters, the viscosity at firing, the firing temperature and time used.

The invention makes preferably use of non-/weak-colouring adherence oxides, which allow light colours to be produced without using a multi-layer enamelling process.

Using this method, an enamelled substrate is obtained whose basic colours varies between grey and milky beige.

Unless stated otherwise, percentages expressed herein refer to percentages by weight (indicated as % by weight (wt %) or % by mass (m %)).

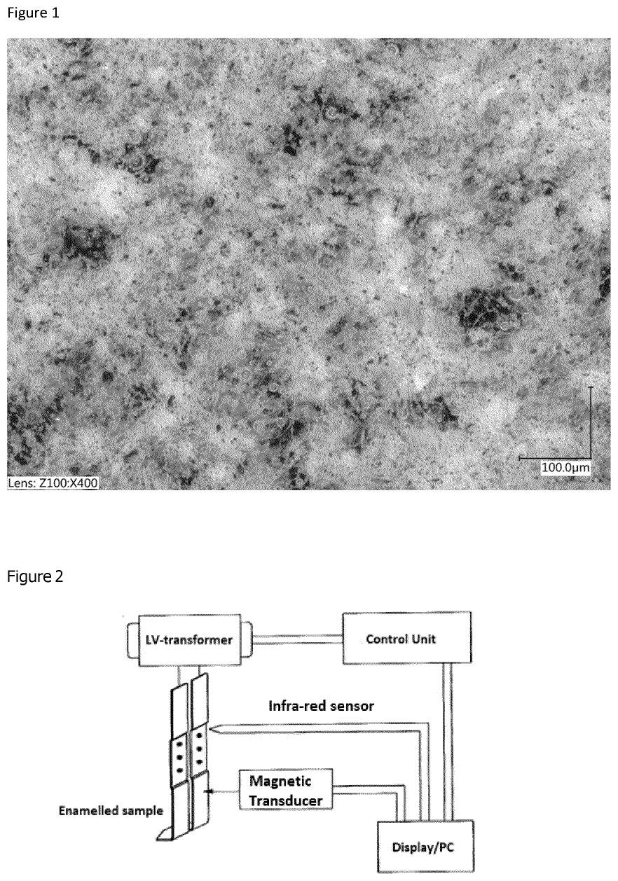

To adjust the colour and colour depth, a crystallising frit can be added in percentages of 0-60 wt %, preferably 5 to 60% by weight. This results in a surface as shown in FIG. 1.

FIG. 1 shows an enamel coating produced by using the frit composition of the present invention or a preferred one thereof. Both frits, namely the molybdenum-containing frit and the crystallizing frit, form distinct parts in the enamel coating. The dark areas as shown in FIG. 1 belong to the molybdenum-containing frit and the white areas as shown in FIG. 1 belong to the crystallizing frit. The dark areas are transparent whereas the white areas are opaque.

Preferably, the mixture of molybdenum, iron and antimony oxides, preferably combined with an adherence promoter creates a complex mechanism which replaces the one of NiO and/or CoO. Preferably, the adherence promoter is Sb-containing crystals (e.g. antimonate and Uverite).

Without being bound to a theory, during the adherence mechanism, a certain amount of iron atoms from the steel will go into solution into the enamel. Hereby, the iron oxide percentage rises and the color become more significant. A greenish grey is preferably the result and is seen as the “dark” part of the coloring as shown in FIG. 1.

The light/white color is a result of crystallisation of the crystallizing frit. Due to the insolubility/heterogeneity of this frit, crystallisation will occur on the surface of the enamel (least nucleation energy required). During the firing, these crystals grow until a certain point.

This crystallizing frit is preferably strong chemical resistant due to the high SiO₂ and CeO₂-percentage, resulting in a strong acid/water/base resistance compared to other enamels.

This crystallisation results in many whitish areas. These areas combined with the “darker” areas of the molybdenum containing frit result in a neutral/light grey color. Combined with pigments, several colors can be achieved.

In an exemplary embodiment, a mixture of a molybdenum frit and a crystallising frit is used as the basic frit composition. In addition to these glass frits, further mill additions are possible. In addition to the typical oils added for electrostatic powder application, adherence promoters can be added. These will improve adherence between the steel and enamel during the firing step, in combination with the molybdenum-containing glass frit. Other mill additives can be clay, adhesion promoter H1019, potassium nitrite, manganese carbonate, and other additives known in the field (H1019 is a commercial name of an adherence promoter of PEMCO Company).

A basic formulation of Pyro Light which is a preferred enamel coating composition of the present invention is shown below:

| | wt % |
|---|---|
| Molybdenum-containing glass frit | 40-100% |
| Crystallising glass frit | 0-60% |
| Adherence promoter | 0-8 g/100 g frit |
| Oil | 0.20 ml/100 g frit |

This formula provides all the necessary properties to the substrate, which conventional enamels also contain. The main ones are:
1. Smooth and even surface
2. Good colour depth and colour strength
3. Chemical resistance to acids, bases, and water
4. Good adherence between enamel and steel (tested according to EN10209)

In addition, the properties required for pyrolytic ovens:
1. Metallisation-free
2. Coefficient of expansion of the enamel that qualifies for pyrolytic cleaning cycles (DIN511175)
3. Food contact resistant (ISO4531)

Pyrolytic ovens use pyrolysis to clean the interior after use. The furnace is heated to a temperature of 450-500° C. This causes the base material of the oven to expand, and tensions may arise between the steel and enamel. To reduce such tensions between these during a cleaning cycle, the enamel must have a certain coefficient of expansion. An Fa value between 2.3-3.2 mm is acceptable. This is measured using the KLOTZ test, DIN51175.

The enamelled plate is heated up to about 650° C. in a short time, while the deflection of the plate is measured as a function of temperature. When the final temperature of the heating is reached, the current is interrupted, and the cooling phase starts. During this cooling phase, the values are calculated. The Fa value indicates the compressive stress and is a measure for the probability of enamel chip-off during the pyrolysis cycle (FIG. 2).

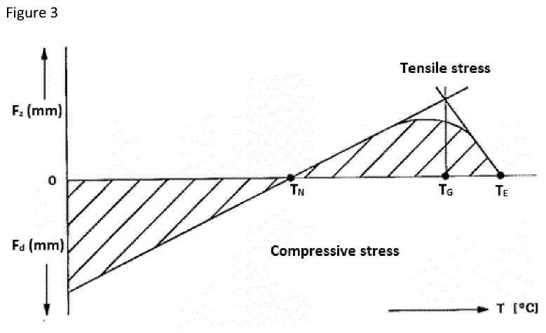

Derived from the graph (FIG. 3), there is a certain amount of compressive stress at room temperature between the substrate and the enamel. This means that the enamel is under constant tension, which affects the adherence. Due to this compressive stress, a lower force is required to break the bond between the substrate and the enamel. Therefore, a balance between compressive stress and adherence must be achieved. One of the important innovative aspects of the invention is that the composition of the light-coloured frit and the Pyro Light formulations leads to an appropriate compressive stress and adherence.

Pyrolytic ovens encounter food, so a high chemical resistance is needed, and more specifically a food contact resistance. This is measured using ISO4531. The enamelled plate is exposed to a 3 wt % acetic acid solution at a temperature of 95° C. This is done in 3 different cycles, whereby one cycle equals a time span of 2 hours. After each cycle, the solvent is renewed, and the concentration of the dissolved components is analysed. All components must not exceed a predetermined concentration limit. One of the important innovative aspects of the invention is that the composition of the Pyro Light enamels results in good chemical resistance and good adherence.

The enamel coating compositions, preferably Pyro Light, thus meet all the requirements expected of conventional enamels. The difference between the two, however, is that the elements cobalt and nickel have been removed from the frit composition and replaced by non-/weakly coloured adherence oxides, resulting in the colour light grey. Of course, other colours are also possible with this system. Due to the neutrality of the final base colour of the enamel coating compositions, preferably Pyro Light, the colour can be varied considerably by adjusting the milling formula.

These include:
1. Inert material: to obtain a (slight) whitening effect on the colour
2. Pigments: To offer different colours

Pigments are used to create colour. As a result, many different colours are possible. However, as previously mentioned, conventional enamels are severely limited by the strong dark-colouring effect of the frit composition. This is not the case with Pyro Light, due to the light-grey base colour of the glass. As a result, the pigments have a great influence on the obtained colour. Thus, a green colour can be obtained simply by adding a green pigment; the same applies, for example, to brown, blue and so on. It is also possible to add small quantities of strong colouring ions to the frit composition. For example, Cr³⁺ can be used to give the basic frit composition already a green colour. A combination consisting of a pigment and colouring ions in the glass frit can also be used. This makes a wide range of colours possible with direct enamelling, which were not possible before. A green colour in a single-layer system with conventional enamels is inconceivable because chromium oxide is known to break down the adherence between enamel and steel, which is why it was previously only produced using multi-layer enamelling.

To clarify the difference in colour lightness between conventional enamels and the invention, a colour measurement made using a Hunter ColorQuest XE spectrophotometer (D65/10°) is shown below. Using CIELAB colour units, the colour difference can be specified.

| CIELAB D65/10 | Conventional Enamels | Pyro Light |
|---|---|---|
| L | 0-30 | 20-70 |

Since only relatively small quantities of the colouring ions are required for Pyro Light, this does not have a major impact on the adherence, so that the basic properties are retained.

This feature makes this innovative product revolutionary in the field of coloured direct-on enamels.

### EXAMPLES

Some examples are presented below. All enamelling was done on DC03ED steel and 840° C. was used as the firing temperature, for a time of 4 minutes.

The following examples further substantiate the present invention without being limiting.

### Example 1

The frit BB48 in combination with a crystallising frit VP45/4628, an adherence promoter, pigment and oil results in a formulation with good adherence and resistance properties. In addition, it exhibits good surface quality combined with the desired aesthetic properties.

| Name | BB48 (wt %) |
|---|---|
| Al₂O₃ | 0.50 |
| B₂O₃ | 14.40 |
| BaO | 4.80 |
| CaO | 1.30 |
| F | 2.20 |
| Fe₂O₃ | 3.10 |
| K₂O | 1.60 |
| Li₂O | 0.50 |
| MgO | 0.50 |
| MoO₃ | 1.50 |
| Na₂O | 12.20 |
| Sb₂O₃ | 0.30 |
| SiO₂ | 54.30 |
| TiO₂ | 2.80 |
| Total | 100.0 |

| Name | VP45/4628 (wt %) |
|---|---|
| Al₂O₃ | 1.67 |
| B₂O₃ | 13.05 |
| BaO | 0.25 |
| CaO | 1.31 |
| CeO₂ | 12.19 |
| F | 2.02 |
| K₂O | 2.72 |
| Li₂O | 0.78 |
| MgO | 1.05 |
| MoO₃ | 0.33 |
| Na₂O | 9.68 |
| SiO₂ | 49.78 |
| TiO₂ | 1.68 |
| ZrO₂ | 3.49 |
| Total: | 100.0 |

| Example 1 | wt % |
|---|---|
| BB48 - Molybd. Frit | 80.00% |
| VP45/4628 - Crystallising Frit | 20.00% |
| Mill Additions: | |
| Sb-/Ca-titanate | 3.0/100 g frit |
| H294 | 5.0/100 g frit |
| H230 | 2.00/100 g frit |
| FA1260 (=Cupper chromate - Black | 2.00/100 g frit |
| pigment) | |
| MH15-Oil | 0.20 ml/100 g frit |
| (=Polymethylhydrosiloxane) | |
| Adherence | 2 |
| F_{d} | 2.84 mm |

Some of the components identified with their H-numbers in the table above and used in all three examples have the following chemical composition:

| H-number | Name | Formula |
|---|---|---|
| H294 | Spodumene | LiAl(SiO₃)₂ |
| H230 | Blue Clay | A clay mineral |

| CIELAB D65/10 | Example 1 |
|---|---|
| L | 39.15 |
| a | 0.25 |
| b | 2.21 |

VP45/4628, H294, H230, FA1260, FA5218, FA4786 are commercial product names of PEMCO Company—other similar products can also be used.

### Example 2

The second example will result in a light brown enamel that meets all the requirements for the application of pyrolytic ovens. The incorporation of manganese and iron oxide lends a darker colour to the molybdenum frit, whereby a light brown hue is also achieved. This combined with the other milling additives, as shown in the table below, forms a light brown enamelled product.

| Name | KSEP22 (wt %) |
|---|---|
| Al₂O₃ | 0.6 |
| B₂O₃ | 10.2 |
| BaO | 3.0 |
| CaO | 1.1 |
| F | 3.1 |
| Fe₂O₃ | 2.7 |
| K₂O | 5.0 |
| Li₂O | 1.1 |
| MnO₂ | 3.0 |
| MoO₃ | 1.1 |
| Na₂O | 9.5 |
| P₂O₅ | 2.0 |
| Sb₂O₃ | 1.9 |
| SiO₂ | 51.3 |
| SrO | 1.3 |
| TiO₂ | 3.1 |
| Total | 100.0 |

| Example 2 | wt % |
|---|---|
| KSEP22 - Molybd. Frit | 70.00% |
| VP45/4628 - Crystallising Frit (see Example 1) | 30.00% |
| Mill additions: | |
| Manganese Carbonate (MnCO₃) | 2.00/100 g frit |
| H294 (see Example 1) | 8.00/100 g frit |
| FA5218 | 2.00/100 g frit |
| (=Zinc and Ferric chromate - Brown pigment) | |
| MH15-Oil | 0.20 ml/100 g frit |
| (=Polymethylhydrosiloxane) | |
| Adherence | 2 |
| F_{d} | 2.87 mm |

| CIELAB D65/10 | Example 2 |
|---|---|
| L | 46.87 |
| a | 3.28 |
| b | 2.93 |

### Example 3

The third example shows a green enamel that, like the previous examples, meets the imposed criteria. By incorporating a minimum concentration of chromium oxide, a light green base colour can be given to the enamel, which is then enhanced by using a green pigment.

| Name | BB2 (wt %) |
|---|---|
| Al₂O₃ | 0.5 |
| B₂O₃ | 15.5 |
| BaO | 6.6 |
| CaO | 1.2 |
| Cr₂O₃ | 0.2 |
| F | 0.8 |
| Fe₂O₃ | 2.4 |
| K₂O | 1.5 |
| Li₂O | 0.8 |
| MnO₂ | 1.0 |
| MoO₃ | 1.1 |
| Na₂O | 11.5 |
| Sb₂O₃ | 1.9 |
| SiO₂ | 50.1 |
| SrO | 0.1 |
| TiO₂ | 2.9 |
| ZrO₂ | 1.9 |
| Total: | 100.0 |

| Example 3 | wt % |
|---|---|
| BB2 - Molybd. Frit | 85.00% |
| VP45/4628 - Crystallising Frit (see Example 1) | 15.00% |
| Mill Additives | |
| Sb-/Ca-titanate | 6.00/100 g frit |
| H294 (see Example 1) | 5.00/100 g frit |
| H230 (see Example 1) | 2.00/100 g frit |
| FA4786 | 1.00/100 frit |
| (=Chromium oxide Cr203 - Green pigment) | |
| MH15-Oil | 0.20 ml/100 g frit |
| (=Polymethylhydrosiloxane) | |
| Adherence | 3 |
| F_{d} | 2.83 mm |

| CIELAB D65/10 | Example 3 |
|---|---|
| L | 53.93 |
| a | −7.94 |
| b | −1.49 |

Although limited embodiments of the molybdenum-containing frits, the frit compositions, the enamel coating compositions, the enamel coatings and their components and their concentrations thereof have been specifically described and illustrated herein, many modifications and variations will be apparent to those skilled in the art. Accordingly, it is to be understood that the catheter assemblies and their components constructed according to principles of the disclosed frits, compositions, coatings and method may be embodied other than as specifically described herein. The disclosure is also defined in the following aspects and claims.

### ASPECTS

1. Good-adhering enamel coatings that are applied as a single-layer system to steel and have a light colour due to the low content of dark-coloured elements.
2. Enamel coatings according to aspect 1, with an L-value between 10 and 70, or more specifically with an L value between 30 and 70.
3. Enamel coatings according to any one of aspects 1 and 2, applied by electrostatic powder spraying.
4. Enamel coatings according to any one of aspects 1 to 3, using a molybdenum-based adhering frit with MoO₃ between 0.5 and 2 wt %.
5. Enamel coatings according to any one of aspects 1 to 4, using a melt-coloured molybdenum-based adhering frit.
6. Enamel coatings according to any one of aspects 1 to 5, whereby an opaque frit is added in amounts of 5% to 60%.
7. Enamel coatings according to any one of aspects 1 to 6, whereby mill additives are added on top of the frit during milling in amounts of 0.2 to 8 g/100 g frit.
8. Enamel coatings according to any one of aspects 1 to 7, whereby colour pigments are added in amounts of 0.1 to 3 g/100 g frit.
9. Enamel coatings according to any one of aspects 1 to 8, with high compressive stress at room temperature, corresponding to an F_{d} value above 2.30 mm.

1. A molybdenum-containing frit comprising
(a) molybdenum oxide, preferably in form of MoO₃, and
(b) antimony oxide, preferably in form of Sb₂O₃.

2. The molybdenum-containing frit according to claim 1, which further comprises iron oxide, preferably in form of Fe₂O₃.

3. The molybdenum-containing frit according to claim 1, which is free of cobalt oxide and/or nickel oxide, preferably in form of CoO and NiO.

4. The molybdenum-containing frit according to claim 1, which contains at least 50% by weight SiO₂ (based on the total dry weight of the molybdenum-containing frit).

5. The molybdenum-containing frit according to claim 1, which contains 1 to 8% by weight TiO₂ (based on the total dry weight of the molybdenum-containing frit).

6. The molybdenum-containing frit according to claim 1, which contains less than 3% by weight Fluor (based on the total dry weight of the molybdenum-containing frit).

7. The molybdenum-containing frit according to claim 1, which contains 10 to 20% by weight alkali oxides, preferably K₂O, Na₂O and Li₂O (based on the total dry weight of the molybdenum-containing frit).

8. The molybdenum-containing frit according to claim 1, which contains less than 10 by weight earth alkali oxides, preferably BaO and CaO (based on the total dry weight of the molybdenum-containing frit).

9. The molybdenum-containing frit according to claim 1, which contains the following components (each % by weight is based on the total dry weight of the molybdenum-containing frit):
MoO₃, preferably 0.5 to 2.0% by weight,
Sb₂O₃, preferably 0.1 to 3.0% by weight,
Fe₂O₃, preferably 1.5 to 5.0% by weight,
Al₂O₃, preferably 0.5 to 3.0% by weight,
B₂O₃, preferably 5.0 to 20.0% by weight,
BaO, preferably 1.0 to 10.0% by weight,
CaO, preferably 0.1 to 5.0% by weight,
F, preferably 0.1 to 5.0% by weight,
K₂O, preferably 0.5 to 10.0% by weight,
Li₂O, preferably 0.1 to 3.0% by weight,
Na₂O, preferably 5.0 to 20.0% by weight,
SiO₂, preferably 40.0 to 60.0% by weight, and
TiO₂, preferably 1.0 to 8.0% by weight,
wherein all components add up to 100% by weight.

10. A frit composition comprising:
(a) a molybdenum-containing frit according to claim 1; and
(b) a crystallizing frit.

11. The frit composition according to claim 10, wherein the crystallizing frit contains cerium oxide, preferably in form of CeO₂, preferably 10.0 to 15.0% by weight thereof, and/or silicon oxide, in form of SiO₂, preferably 45.0 to 55.0% by weight thereof.

12. The frit composition according to claim 10, wherein the crystallizing frit contains the following components (each % by weight is based on the total dry weight of the crystallizing frit):
MoO₃, preferably less than 1.0% by weight,
Al₂O₃, preferably 0.5 to 5.0% by weight,
B₂O₃, preferably 5.0 to 20.0% by weight,
BaO, preferably 0.1 to 5.0% by weight,
CaO, preferably 0.5 to 5.0% by weight,
CeO₂, preferably 5.0 to 20.0% by weight,
F, preferably 0.5 to 5.0% by weight,
K₂O, preferably 0.1 to 5.0% by weight,
Li₂O, preferably 0.1 to 5.0% by weight,
MgO, preferably 0.1 to 5.0% by weight,
Na₂O, preferably 5.0 to 15.0% by weight,
SiO₂, preferably 40.0 to 60.0% by weight,
TiO₂, preferably 1.0 to 5.0% by weight, and
ZrO₂, preferably 1.0 to 5.0% by weight,
wherein all components add up to 100% by weight.

13. The frit composition according to claim 10, which contains 40 to 95% by weight of the molybdenum-containing frit and 5 to 60% by weight of the crystallizing frit.

14. An enamel coating composition comprising:
(a) a frit composition according to claim 10; and
(b) a liquid medium.

15. The enamel coating composition according to claim 14, wherein the liquid medium is an oil and/or a solvent.

16. The enamel coating composition according to claim 14, which further contains at least one of the components selected form the group consisting of one or more adherence promotors, one or more color pigments, one or more mill additives and combinations thereof.

17. A method for coating metal substrate with enamel, which comprises the following steps of:
(a) providing a metal substrate having a first surface and an enamel coating composition according to claim 13;
(b) directly applying the enamel coating composition to the first surface of the metal substrate to form a coated metal substrate; and
(c) firing the coated metal substrate to form an enamel coated metal substrate.

18. Method according to claim 17, wherein the applying pursuant to step (b) is conducted by electrostatic powder spraying.

19. Method according to claim 17, wherein the firing step (c) is conducted at a temperature of from 760° C. to 860° C. for 2 to 10 minutes.

20. Enamel coating produced by a method according to claim 17.

21. The enamel coating according to claim 20, which has a lightness value, L in CIELAB, of 20 to 70.

22. Use of an enamel coating composition according to claim 14 as enamel which is directly applied to a metal substrate.
